(19) United States
(12) Patent Application Publication
(10) Pub. No.: US 2017/0289490 A1
(43) Pub. Date: Oct. 5, 2017

(54) TV ENERGY EFFICIENCY CONTROL METHOD AND ELECTRONIC EQUIPMENT

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Bin Cheng, Tianjin (CN)

(21) Appl. No.: 15/240,704

(22) Filed: Aug. 18, 2016

Related U.S. Application Data
(63) Continuation of application No. PCT/CN2016/089181, filed on Jul. 7, 2016.

(30) Foreign Application Priority Data
Mar. 30, 2016 (CN) 201610191462.5

(51) Int. Cl. H04N 5/63; H04N 21/443; G06F 1/32; H04N 5/57

(52) U.S. Cl. CPC H04N 5/63; H04N 5/57; H04N 21/4436; G06F 1/3218; G06F 1/3265

(57) ABSTRACT

The embodiments of the present disclosure disclose a method and electronic device for controlling television energy efficiency, and a television. Wherein the method for controlling television energy efficiency includes: acquiring a cache address of frame data input by an external device from an application layer; searching for frame data corresponding to the cache address; extracting energy consumption parameter information from the frame data; and performing energy efficiency control for the television according to the energy consumption parameter information. In the technical solution of the present disclosure, the cache address of the frame data is acquired from the application layer, and the frame data corresponding to the cache address is searched for according to the cache address, so as to realize acquisition of the frame data input by the external device. Thus, the energy efficiency control is performed for the television according to information related to the frame data, so as to realize energy efficiency control for the television when the frame data is input by the external device.

### CROSS-REFERENCE TO RELATED APPLICATIONS

This application is a continuation of International PCT Patent Application No. PCT/CN2016/089181, filed Jul. 7, 2016 (attached hereto as an Appendix), and claims benefit/priority of Chinese patent application entitled “Method and Electronic Device for Controlling Television Energy Efficiency”, application number 201610191462.5, filed with the State Intellectual Property Office of China on Mar. 30, 2016, which are all incorporated herein by reference in entirety.

### TECHNICAL FIELD

The application relates to the field of television technology, and more particularly, to a method and electronic device for controlling television energy efficiency.

### BACKGROUND

Green, low carbon, energy saving and environmental protection are hotspots concerned by the society. In order to make the television business meet the requirements of energy saving and environmental protection, the standard of Minimum allowable values of energy efficiency and energy efficiency grades for flat panel televisions has been formally implemented in China. Wherein, an important indicator is an energy efficiency index of the television, i.e., display area×luminance÷ power consumption. Wherein the energy efficiency index of the television can be divided into three grades: a first grade of the energy efficiency index is 1.4 cd/w, which represents the highest level of the similar products on the current market; a second grade of the energy efficiency index is 1.0 cd/w, which represents an average level of the similar products on the current market; and a third grade of the energy efficiency index is 0.6 cd/w, which represents an access level of the market and is mainly used for weeding out the products with a high energy consumption on the market. Thus, how to perform energy efficiency control for the television is a problem that one of ordinary skilled in the art has to face.

The energy efficiency control for the television can be realized in terms of software and hardware, respectively. Wherein, in terms of the software, the energy efficiency of the television can be improved by performing corresponding process for frame data, so as to reduce the quality of the screen.

Under normal conditions, the television is further provided with an external device interface (e.g., a USB interface), through which a user can voluntarily connect an external device according to requirements and expand functions of the television, so as to bring rich personalized experiences for the user. Nevertheless, in implementing the present disclosure, the inventor has found that at least the following problems exist in the related art. That is, since the external device commonly is a third-party device, the internal program thereof is solidified and the setting has an authority, such that the frame data input by the external device cannot be directly obtained, and thereby, the energy efficiency of the television cannot be controlled.

### SUMMARY

In order to overcome the problem existing in the related technology, the present disclosure provides a method and an electronic device for controlling television energy efficiency.

In the first aspect, the embodiment of the present disclosure provides a method for controlling television energy efficiency, which includes:
acquiring a cache address of frame data input by an external device from an application layer; searching for frame data corresponding to the cache address; extracting energy consumption parameter information from the frame data; and performing energy efficiency control for the television according to the energy consumption parameter information. In the embodiment of the present disclosure, the cache address of the frame data is acquired from the application layer, and the frame data corresponding to the cache address is searched for according to the cache address, so as to realize acquisition of the frame data input by the external device. Thus, the energy efficiency control is performed for the television according to information related to the frame data, so as to realize the energy efficiency control for the television when the frame data is input by the external device.

In the second aspect, the embodiment of the present disclosure further provides a non-transitory computer readable storage medium is further provided, wherein the storage medium may store instructions, and when the instructions are executed, part or all of steps of the respective modes in the method for controlling television energy efficiency provided by the first aspect of the present disclosure can be realized.

In the third aspect, the embodiment of the disclosure further provides an electronic device, which includes: one or more processors; and a memory for storing instructions executable by the one or more processors, wherein the instructions that cause to perform any one of the methods for controlling television energy efficiency provided by the present disclosure.

It could be seen from the above technical solution that the energy efficiency control solution of the television provided by the embodiment of the present disclosure is to: acquire a cache address of frame data input by an external device from an application layer; search for frame data corresponding to the cache address; extract energy consumption parameter information from the frame data; and perform energy efficiency control for the television according to the energy consumption parameter information.

In the embodiment of the present disclosure, the cache address of the frame data is acquired from the application layer, and the frame data corresponding to the cache address is searched for according to the cache address, so as to realize acquisition of the frame data input by the external device. Thus, the energy efficiency control is performed for the television according to information related to the frame data, so as to realize the energy efficiency control for the television when the frame data is input by the external device.

It should be understood that, the above general description and the detailed description hereinafter are merely exemplary and explanatory, which are not used to limit the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a scene schematic diagram provided by an embodiment of the present disclosure.

FIG. 2 is a flow schematic diagram of a method for controlling television energy efficiency provided by an embodiment of the present disclosure.

FIG. 3 is a flow schematic diagram of a method for controlling television energy efficiency provided by an embodiment of the present disclosure.

FIG. 4 is a flow schematic diagram of a method for controlling television energy efficiency provided by an embodiment of the present disclosure.

FIG. 5 is a flow schematic diagram of a method for controlling television energy efficiency provided by an embodiment of the present disclosure.

FIG. 6 is a flow schematic diagram of a method for controlling television energy efficiency provided by an embodiment of the present disclosure.

FIG. 7 is a flow schematic diagram of a method for controlling television energy efficiency provided by an embodiment of the present disclosure.

FIG. 8 is a flow schematic diagram of a method for controlling television energy efficiency provided by an embodiment of the present disclosure.

FIG. 9 is a flow schematic diagram of a method for controlling television energy efficiency provided by an embodiment of the present disclosure.

FIG. 10 is a flow schematic diagram of a method for controlling television energy efficiency provided by an embodiment of the present disclosure.

FIG. 11 is a structural schematic diagram of a device for controlling television energy efficiency provided by an embodiment of the present disclosure.

FIG. 12 is a structural schematic diagram of an energy consumption parameter information extracting module provided by an embodiment of the present disclosure.

FIG. 13 is a structural schematic diagram of an energy efficiency control module provided by an embodiment of the present disclosure.

FIG. 14 is a structural schematic diagram of an energy efficiency control executing submodule provided by an embodiment of the present disclosure.

FIG. 15 is a structural schematic diagram of an energy efficiency control executing submodule provided by an embodiment of the present disclosure.

FIG. 16 is a structural schematic diagram of an energy efficiency control executing submodule provided by an embodiment of the present disclosure.

FIG. 17 is a structural schematic diagram of a frame data searching module provided by an embodiment of the present disclosure.

FIG. 18 is a structural schematic diagram of a frame data searching submodule provided by an embodiment of the present disclosure.

FIG. 19 is a structural schematic diagram of a dynamic frame determining submodule provided by an embodiment of the present disclosure.

FIG. 20 is a structural flowchart of a television provided by an embodiment of the present disclosure.

FIG. 21 is a structural schematic diagram of an electronic device that performs method for controlling television energy efficiency provided by an embodiment of the present disclosure.

### DETAILED DESCRIPTION

Herein, the exemplary embodiments will be explained in detail, and the examples thereof are shown in the figures. When the following description relates to the figures, the same number in different figures indicates the same or similar elements, except for other indications. The embodiment method described in the following exemplary embodiments does not represent all the embodiment methods that are consistent with the present disclosure. In contrast, they are only examples of the device and the method described in the attached claims and consistent with some aspects of the present disclosure.

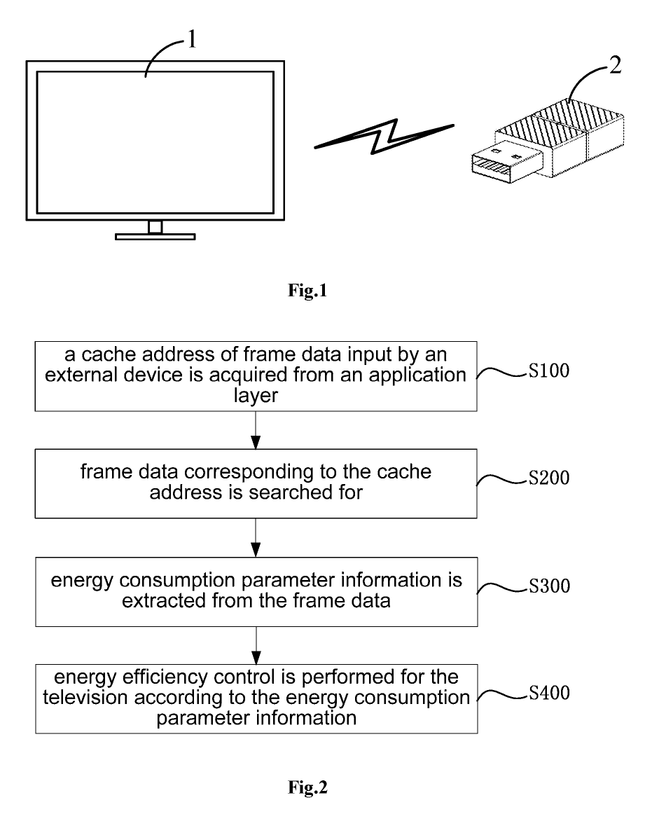

FIG. 1 is a scene schematic diagram provided by an embodiment of the present disclosure. A television 1 is included in FIG. 1. An external device interface (e.g., a USB interface) is arranged on the television 1, through which a user can connect an external device 2 and expand functions of the television 1, such as receiving some particular channel signals or video sources, etc.

Wherein, FIG. 1 merely is a scene schematic diagram of the present disclosure. The specific type, number and correspondence of the television 1 and the external device 2 connected to the television 1 are not limited to the specific methods disclosed in FIG. 1. For instance, the number of the external device 2 may be two or more than two, a method to connect the external device 2 and the television 1 can be a wireless connection, etc, which can be selected by one of ordinary skilled in the art according to his/her own requirements, and are not limited in the present disclosure.

FIG. 2 is a flow schematic diagram of a method for controlling television energy efficiency provided by an embodiment of the present disclosure. As shown in FIG. 2, the method for controlling energy efficiency of the television includes the following steps.

In step S100, a cache address of frame data input by an external device is acquired from an application layer.

In the embodiment of the present disclosure, after the external device is connected to the television through the external device interface, frame data in the external device is transmitted to an external device adaptation layer via the external device interface, wherein the external device adaptation layer transmits the frame data to a buffer to perform cache and transmits the cache address of the frame data in the buffer to the application layer. The cache address is transmitted to a display adaptation layer after the application layer receives the cache address of the frame data, and the display adaptation layer searches for frame data corresponding to the cache address in the buffer according to the cache address, thereby displaying a corresponding image on a display screen according to the frame data.

Although according to the program set by the external device, frame data output by the external device cannot be directly acquired in a hardware layer and an adaptation layer since the frame data is in a packaging state in the hardware layer and the adaptation layer, the cache address in the buffer will be transmitted to the application layer after the external device adaptation layer transmits the frame data to the buffer to perform cache. Therefore, in the embodiment of the present disclosure, the cache address of the frame data input by the external device can be acquired from the application layer.

In step S200, frame data corresponding to the cache address is searched for.

Since the frame data in the buffer has a one-to-one mapping relationship with the cache address, the frame data can be uniquely determined after the cache address is determined. At this time, since the cache address of the frame data has been acquired in the application layer, the corresponding frame data can be searched for in the buffer according to the cache address. Wherein, the method to search for the frame data is not specifically limited in the embodiment of the present disclosure, and thus one of ordinary skilled in the art can select different search methods according to actual requirements, which should fall into the protection scope of the present disclosure.

In step S300, energy consumption parameter information is extracted from the frame data.

The energy efficiency of the television is a ratio of the area of the display screen to the energy consumption. In a case where the area of the display screen is fixed, only the energy consumption of the television is reduced to improve the energy efficiency of the television. Since the quality of the image displayed on the display screen can influence the energy consumption of the television (the higher the quality of the image, the higher the energy consumption of the television), the energy consumption of the television can be determined according to information (i.e., frame data) of the image displayed on the display screen, so as to execute a corresponding energy efficiency control strategy for the television.

In the embodiment of the present disclosure, the frame data includes detailed information of the image, including luminance, contrast, resolution, pixel value, etc. Since it needs to control the energy efficiency of the television according to the frame data in the embodiment of the present disclosure, information (i.e., energy consumption parameter information) related to the energy consumption is extracted from the frame data.

In step S400, energy efficiency control is performed for the television according to the energy consumption parameter information.

In the embodiment of the present disclosure, the corresponding energy efficiency control strategy can be executed for the television according to energy consumption parameter information only after the energy consumption parameter information is determined.

For instance, if the energy consumption parameter information is larger than the preset energy consumption parameter information threshold value, it is indicated that the current energy consumption of the television has exceed the set energy consumption standard, and thus the current energy consumption of the television is reduced to realize energy efficiency control for the television. If the energy consumption parameter information is equal to or smaller than the preset energy consumption parameter information threshold value, it is indicated that the current energy consumption of the television does not exceed the set energy consumption standard, and thus the current energy consumption state of the television is maintained. Wherein, the specific method to reduce the current energy consumption of the television is not limited in the embodiment of the present disclosure, and thus one of ordinary skilled in the art can reduce the power consumption of the corresponding devices of the television according to actual requirements, which should fall into the protection scope of the present disclosure.

In the embodiment of the present disclosure, the cache address of the frame data is acquired from the application layer, and the frame data corresponding to the cache address is searched for according to the cache address, so as to realize acquisition of the frame data input by the external device. Thus, the energy efficiency control is performed for the television according to information related to the frame data, so as to realize the energy efficiency control for the television when the frame data is input by the external device.

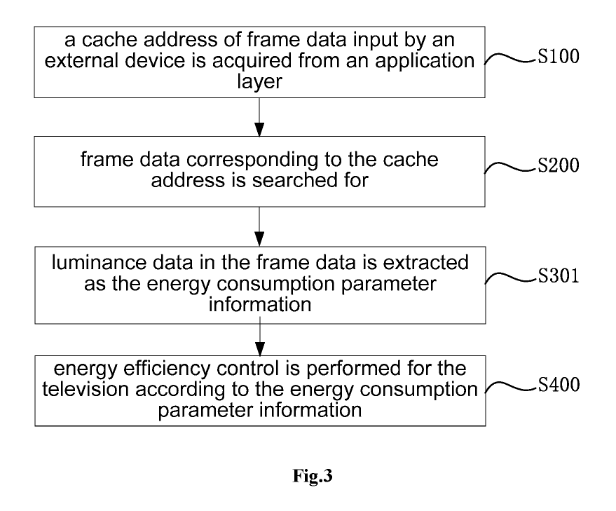

In another embodiment of the present disclosure, as shown in FIG. 3, step S300 of the embodiment shown in FIG. 2 may include the following step:
In step S301, luminance data in the frame data is extracted as the energy consumption parameter information.

The frame data includes detailed information of the image displayed on the display screen, including luminance, contrast, resolution, pixel value, etc. Since the luminance of the image has a great influence on the energy consumption of the television, luminance data in the frame data can be extracted as the energy consumption parameter information in the embodiment of the present disclosure.

Of course, the above content is only a specific implementation method illustrated in the present disclosure. One of ordinary skilled in the art can extract other information in the frame data as energy consumption parameter information according to actual requirements, which should fall into the protection scope of the present disclosure. For example, resolution data in the frame data can be extracted as energy consumption parameter information.

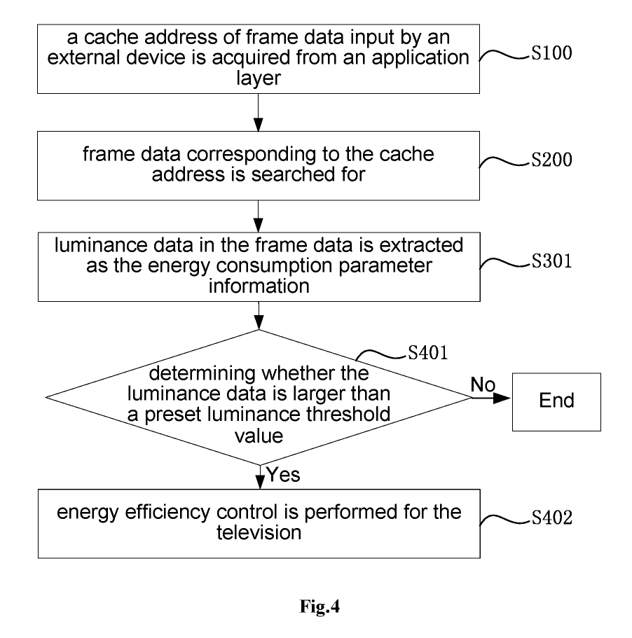

In another embodiment of the present disclosure, as shown in FIG. 4, step S400 of the embodiment shown in FIG. 3 may include the following step:
In step S401, whether the luminance data is larger than a preset luminance threshold value is determined.

It is easily understood that if the current energy efficiency of the television conforms to the energy efficiency standard, it does not need to perform energy efficiency control for the television; if the current energy efficiency of the television does not conform to the energy efficiency standard, it needs to reduce the current energy consumption of the television. That is, the energy efficiency control is performed for the television to make it meet the energy efficiency standard.

In the embodiment of the present disclosure, a luminance threshold value is set according to the energy efficiency standard of the television, i.e., serving the luminance threshold value as a standard to determine whether it is necessary to perform energy efficiency control for the television. Specifically, it is determined whether the luminance data is larger than the preset luminance threshold value, and if the luminance data is larger than the preset luminance threshold value, step S402 is performed; otherwise, the flow ends.

In step S402, energy efficiency control is performed for the television.

The energy efficiency of the television is a ratio of the area of the display screen to the energy consumption. In a case where the area of the display screen is fixed, only the energy consumption of the television is reduced to improve the energy efficiency of the television. In the embodiment of the present disclosure, the energy efficiency of the television can be improved by a method of reducing the energy consumption of the television, thereby controlling the energy efficiency of the television in a standard level and realizing the energy efficiency control for the television. Wherein, the specific method to reduce the energy consumption of the television is not limited in the embodiment of the present disclosure, and thus one of ordinary skilled in the art can use different technical means according to actual requirements, which should fall into the protection scope of the present disclosure.

Since the luminance of the image has a great influence on the energy consumption of the television, the accuracy of the energy efficiency control can be improved by using luminance data in the frame data as a standard to determine whether it is necessary to perform the energy efficiency control.

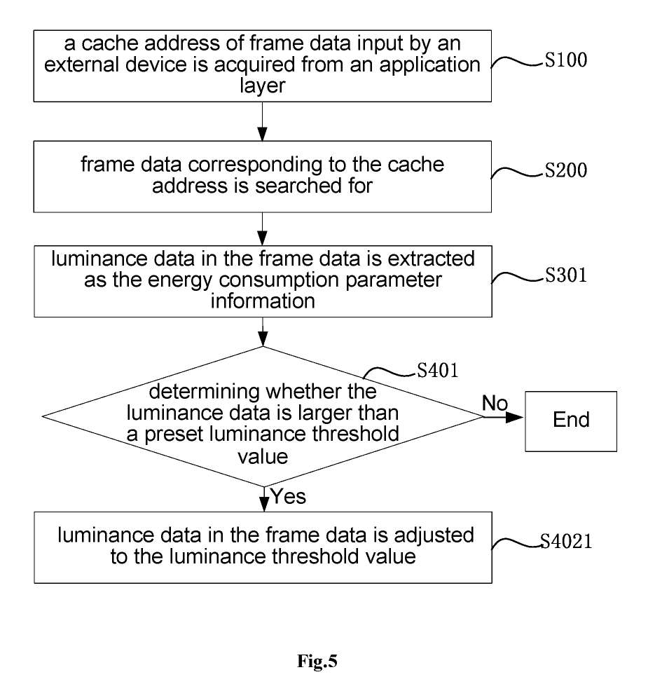

In another embodiment of the present disclosure, as shown in FIG. 5, step S402 of the embodiment shown in FIG. 4 may include the following step:
In step S4021, luminance data in the frame data is adjusted to the luminance threshold value.

As for the television, the energy consumption mainly depends on the display screen, i.e., reduction of the whole energy consumption of the television means to reduction of the energy consumption of the display screen. Wherein, the energy consumption of the display screen is mainly used for displaying an image, and thus the energy consumption of the display screen can be reduced by adjusting the image displayed by the display screen.

In addition, since the luminance of the image has a great influence on the energy consumption, the energy consumption of the display screen can be reduced by adjusting the luminance of the image in the embodiment of the present disclosure, specifically, adjusting luminance data in the frame data to the luminance threshold value. Wherein, the frame data represents data of the image to be displayed by the display screen, and luminance data in the frame data represents a luminance of the image.

For instance, the current luminance of the image is 500 cd/m², and the preset luminance threshold value is 450 cd/m². After comparison, if it is determined that the current luminance (500 cd/m²) of the image is larger than the preset luminance threshold value (450 cd/m²), the luminance of the image is adjusted to the luminance threshold value, i.e., adjusting the luminance of the image to 450 cd/m². Since the luminance threshold value is a luminance value set in accordance with the energy efficiency standard, the energy efficiency of the television can be enabled to meet the energy efficiency standard by adjusting the luminance data to a size of the luminance threshold value.

In the embodiment of the present disclosure, the luminance threshold value is used as a standard to adjust the luminance of the image, so as to improve the accuracy of the energy efficiency control for the television.

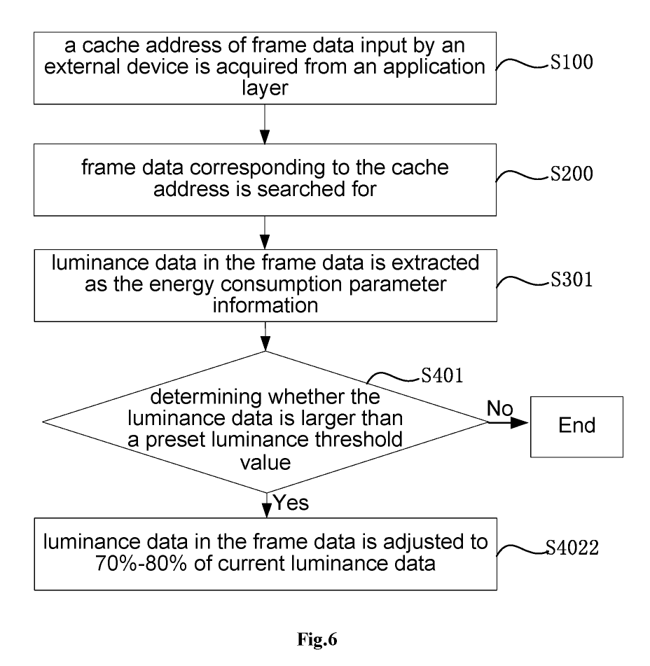

In another embodiment of the present disclosure, as shown in FIG. 6, step S402 of the embodiment shown in FIG. 4 may include the following step:
In step S4022, luminance data in the frame data is adjusted to 70%-80% of current luminance data.

The embodiment of the present disclosure is basically similar with the above embodiments, which also reduces the energy consumption of the television by reducing the luminance of the image. The difference is that if it is determined that the luminance data is larger than the preset luminance threshold value in the embodiment of the present disclosure, the luminance of the image displayed by the display screen is directly adjusted to 70%-80% of current luminance, specifically, adjusting luminance data in the frame data to 70%-80% of the current luminance data. Wherein, the adjustment ratio of the luminance data can be arbitrary data among 70%-80%, which is not limited in the present disclosure.

For instance, the current luminance of the image is 500 cd/m², the preset luminance threshold value is 450 cd/m², and the adjustment ratio of the luminance data is 80%. After comparison, if it is determined that the current luminance (500 cd/m²) of the image is larger than the preset luminance threshold value (450 cd/m²), the luminance of the image is adjusted to 80% of the current luminance, i.e., adjusting the luminance of the image to 400 cd/m². Since the adjusted image luminance is lower than the luminance threshold value, the energy efficiency control for the television can be realized by adjusting the luminance of the image to make the television meet the energy efficiency standard.

That is to say, in the embodiment of the present disclosure, the data processing amount of the television is reduced by equal-proportionally reducing directly according to the current luminance of the image, rather than taking the luminance threshold value as a standard to adjust the luminance of the image any more, which is easily implemented.

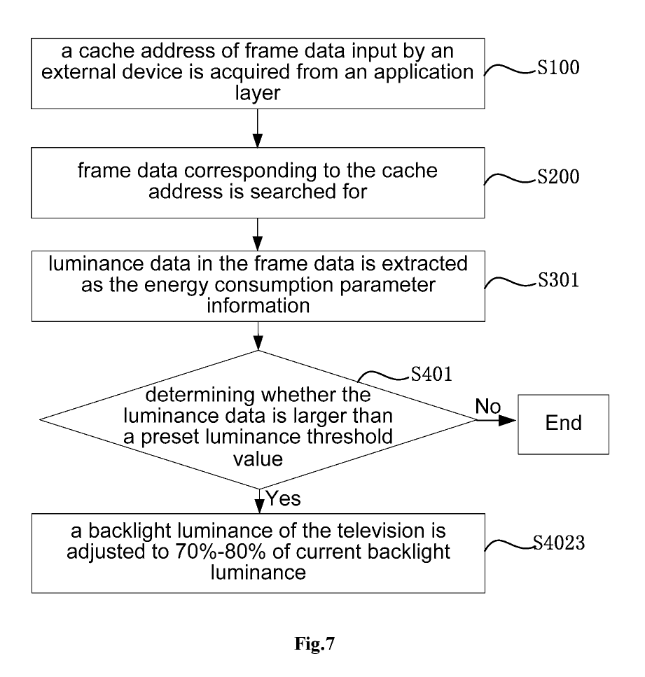

In another embodiment of the present disclosure, as shown in FIG. 7, step S402 of the embodiment shown in FIG. 4 may include the following step:
In step S4023, a backlight luminance of the television is adjusted to 70%-80% of current backlight luminance.

The display screen provides the backlight luminance by the backlight, and the backlight is always in a lightening state after the television is opened. Therefore, in the embodiment of the present disclosure, the energy consumption of the television can be reduced by adjusting the luminance of the backlight, thereby realizing the energy efficiency control for the television.

Wherein, one of ordinary skilled in the art can select an arbitrary numerical value among 70%-80% as an adjustment ratio of the backlight according to actual requirements, which is not limited in the present disclosure.

Since the backlight is merely a light-emitting device in the television, the energy efficiency control can be performed for the television by adjusting the luminance of the backlight, which is easily implemented.

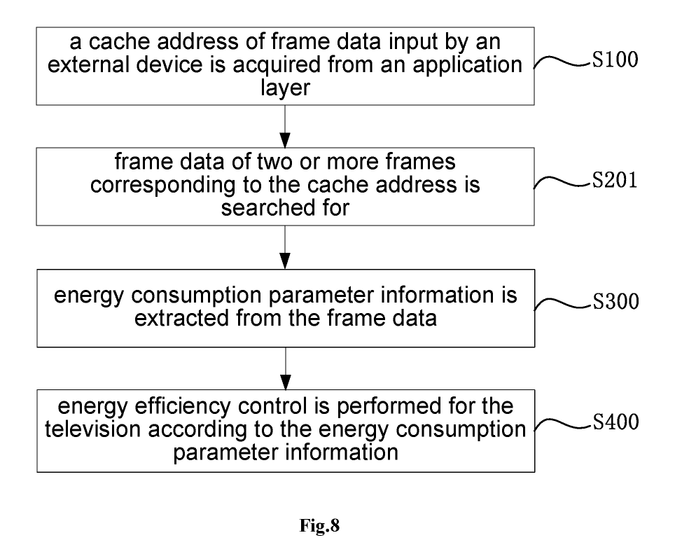

In another embodiment of the present disclosure, as shown in FIG. 8, step S200 of the embodiment shown in FIG. 2 may include the following step:
In step S201, frame data of two or more frames corresponding to the cache address is searched for, wherein the frame data of two or more frames is continuous frame data.

Since the frame data is a continuous data stream, frame data of two or more frames can be searched for according to the cache address, in order to determine types of the frame data in the subsequent step. Wherein, the number of the frame data may be an arbitrary numerical value of more than two frames, e.g. three frames, four frames, five frames, etc., which is not limited in the present disclosure.

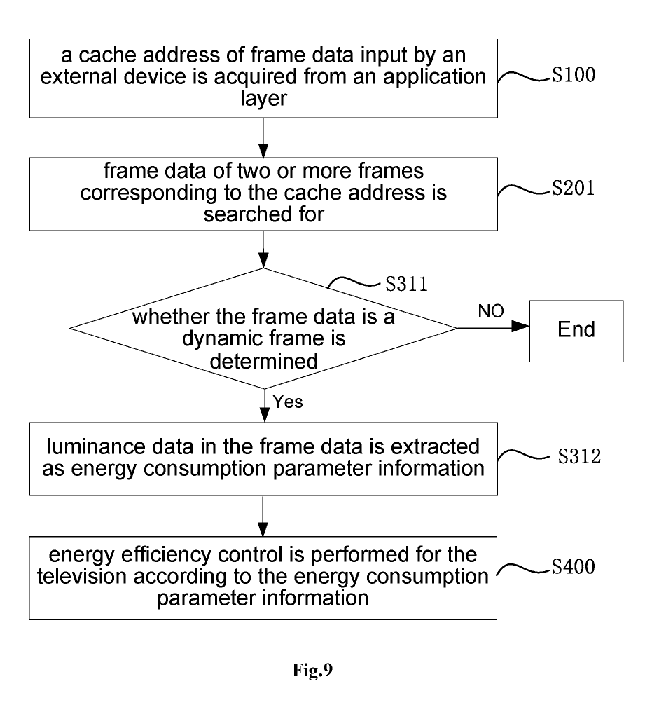

In another embodiment of the present disclosure, as shown in FIG. 9, step S300 of the embodiment shown in FIG. 8 may include the following step:
In step S311, whether the frame data is a dynamic frame is determined.

In a normal case, the screens played in the television include a dynamic screen (such as television play or movie) and a static screen (such as static pictures), wherein the data frame corresponding to the dynamic screen is a dynamic frame, and the data frame corresponding to the static screen is a static frame.

Since the television has a higher energy consumption while playing the dynamic screen, and has a lower energy consumption while playing the static screen, it merely needs to perform energy efficiency control for the television when the television plays the dynamic screen. In the embodiment of the present disclosure, it is first determined whether the frame data is the dynamic frame after the frame data corresponding to the cache address is searched for. If it is determined that the frame data is the dynamic frame, the procedure advances to step S312, otherwise, the procedure ends.

In step S312, luminance data in the frame data is extracted as energy consumption parameter information.

In the embodiment of the present disclosure, luminance data in the frame data is extracted as the energy consumption parameter information if the frame data is the dynamic frame. That is to say, the luminance data in the frame data can be extracted only if the frame data is the dynamic frame, so as to perform energy efficiency control for the television in the subsequent step. If the frame data is the static frame, it does not need to perform energy efficiency control for the television, and thus it is unnecessary to extract the luminance data in the frame data.

In the embodiment of the present disclosure, the type of the frame data is used as an energy efficiency control condition of the television, thereby using different energy efficiency control strategies for different frame data and thus improving the energy efficiency control accuracy of the television.

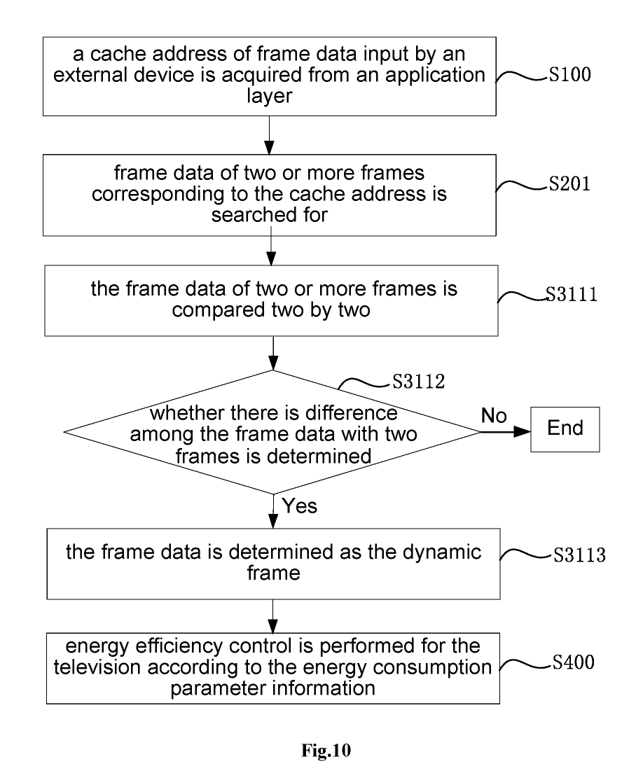

In another embodiment of the present disclosure, as shown in FIG. 10, step S311 of the embodiment shown in FIG. 9 may include the following step:
In step S3111, the frame data of two or more frames is compared two by two.

In the embodiment of the present disclosure, the frame data of each frame represents one image, and comparing the frame data two by two means to comparison of the images represented by respective frames two by two.

For example, if the frame data has two frames (i.e., first frame data and second frame data), the first frame data is compared with the second frame data. As another example, if the frame data has three frames (i.e., first frame data, second frame data and third frame data), the first frame data is compared with the second frame data, the first frame data is compared with the third frame data and the second frame data is compared with the third frame data.

In step S3112, whether there is difference among the frame data with two frames is determined.

If the frame data with two frames are identical, it is represented that two images are identical, i.e., the images played in the television are static images. If the frame data with two frames are different, it is represented that two images are different, i.e., the images played in the television are dynamic images. Thus, the type of the frame data can be determined according to a result of comparison among different frames.

In the embodiment of the present disclosure, if there is difference among the frame data with two arbitrary frames, the procedure advances to step S3113, otherwise, the procedure ends.

For instance, if the frame data includes three frames (i.e., first frame data, second frame data and third frame data), it is determined that the frame data is the dynamic frame if the frame data with two arbitrary frames therein are different, and the procedure advances to step S3113.

In step S3113, the frame data is determined as the dynamic frame.

If there is difference among the frame data with two frames, it is indicated that two images played in the television are different, such that the images played in the television are dynamic images, and the frame data corresponding to the dynamic image is the dynamic frame.

In the embodiment of the present disclosure, the type of the frame data is determined by comparing the frame data with two arbitrary frames, and the determination result is accurate and reliable.

It should be pointed out that, taking a buffer as an example in the embodiment of the present disclosure, the cache position of the frame data is exemplarily explained, which should not be used as limitation for the protection scope of the present disclosure. One of ordinary skilled in the art can use other storage devices to cache the frame data according to actual requirements, which should fall into the protection scope of the present disclosure.

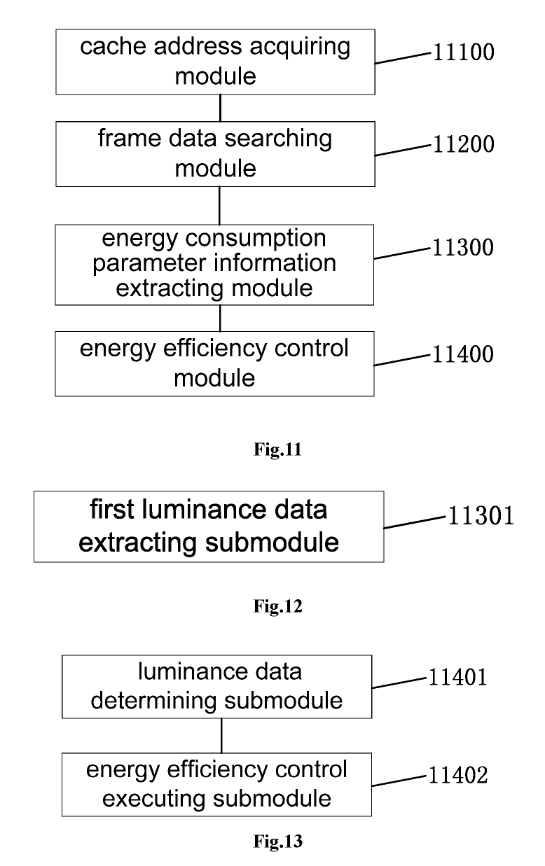

Based on the same conception that is disclosed, the embodiment of the present disclosure further provides a device for controlling energy efficiency of the television. FIG. 11 is a structural schematic diagram of the device for controlling energy efficiency of the television provided by the embodiment of the present disclosure. As shown in FIG. 11, the device for controlling energy efficiency of the television includes:

A cache address acquiring module 11100 is configured to acquire a cache address of frame data input by an external device from an application layer.

In the embodiment of the present disclosure, after the external device is connected to the television by the external device interface, frame data in the external device is transmitted to an external device adaptation layer via the external device interface, wherein the external device adaptation layer transmits the frame data to a buffer to perform cache and transmits a cache address of the frame data in the buffer to the application layer. The cache address is transmitted to a display adaptation layer after the application layer receives the cache address of the frame data, and the display adaptation layer searches for frame data corresponding to the cache address in the buffer according to the cache address, thereby displaying a corresponding image on a display screen according to the frame data.

Although according to the program set by the external device, frame data output by the external device cannot be directly acquired in a hardware layer and an adaptation layer since the frame data is in a packaging state in the hardware layer and the adaptation layer, the cache address in the buffer will be transmitted to the application layer after the external device adaptation layer transmits the frame data to the buffer to perform cache. Therefore, in the embodiment of the present disclosure, the cache address of the frame data input by the external device can be acquired from the application layer.

A frame data searching module 11200 is configured to search for frame data corresponding to the cache address.

Since the frame data has a one-to-one mapping relationship with the cache address, the frame data can be uniquely determined after the cache address is determined. At this time, since the cache address of the frame data has been acquired in the application layer, the corresponding frame data can be searched for according to the cache address.

An energy consumption parameter information extracting module 11300 is configured to extract energy consumption parameter information from the frame data.

The energy efficiency of the television is a ratio of the area of the display screen to the energy consumption. In a case where the area of the display screen is fixed, only the energy consumption of the television is reduced to improve the energy efficiency of the television. Since the quality of the image displayed on the display screen can influence the energy consumption of the television (the higher the quality of the image, the higher the energy consumption of the television), the energy consumption of the television can be determined according to information (i.e., frame data) of the image displayed on the display screen, so as to execute a corresponding energy efficiency control strategy for the television.

In the embodiment of the present disclosure, the frame data includes detailed information of the image, including luminance, contrast, resolution, pixel value, etc. Since it needs to control energy efficiency of the television according to the frame data in the embodiment of the present disclosure, information (i.e., energy consumption parameter information) related to the energy consumption is extracted from the frame data.

An energy efficiency control module 11400 is configured to perform energy efficiency control for the television according to the energy consumption parameter information.

In the embodiment of the present disclosure, the corresponding energy efficiency control strategy can be executed for the television according to energy consumption parameter information only after the energy consumption parameter information is determined.

In the embodiment of the present disclosure, the cache address of the frame data is acquired from the application layer, and the frame data corresponding to the cache address is searched for according to the cache address, so as to realize acquisition of the frame data input by the external device. Thus, the energy efficiency control is performed for the television according to information related to the frame data, so as to realize the energy efficiency control for the television when the frame data is input by the external device.

In another embodiment of the present disclosure, as shown in FIG. 12, the energy consumption parameter information extracting module in FIG. 11 includes:
a first luminance data extracting submodule 11301 is configured to extract luminance data in the frame data as the energy consumption parameter information.

The frame data includes detailed information of the image displayed on the display screen, including luminance, contrast, resolution, pixel value, etc. Since the luminance of the image has a great influence on the energy consumption of the television, luminance data in the frame data can be extracted as energy consumption parameter information in the embodiment of the present disclosure.

In another embodiment of the present disclosure, as shown in FIG. 13, the energy efficiency control module in FIG. 12 includes:
a luminance data determining submodule 11401 is configured to determine whether the luminance data extracted by the first luminance data extracting submodule is larger than a preset luminance threshold value.

It is easily understood that if the current energy efficiency of the television conforms to the energy efficiency standard, it does not need to perform energy efficiency control for the television; if the current energy efficiency of the television does not conform to the energy efficiency standard, it needs to reduce the current energy consumption of the television. That is, the energy efficiency control is performed for the television to make it meet the energy efficiency standard.

In the embodiment of the present disclosure, the luminance threshold value is set according to the energy efficiency standard of the television. That is, the luminance threshold value is used as a standard to determine whether it is necessary to perform energy efficiency control for the television.

An energy efficiency control executing submodule 11402 is configured to perform energy efficiency control for the television if the luminance data is larger than the preset luminance threshold value.

The energy efficiency of the television is a ratio of the area of the display screen to the energy consumption. In a case where the area of the display screen is fixed, only the energy consumption of the television is reduced to improve the energy efficiency of the television. In the embodiment of the present disclosure, the energy efficiency of the television can be improved by a method of reducing the energy consumption of the television, thereby controlling the energy efficiency of the television in a standard level and realizing the energy efficiency control for the television.

Since the luminance of the image has a great influence on the energy consumption of the television, the accuracy of the energy efficiency control can be improved by taking luminance data in the frame data as a standard to determine whether it is necessary to perform the energy efficiency control.

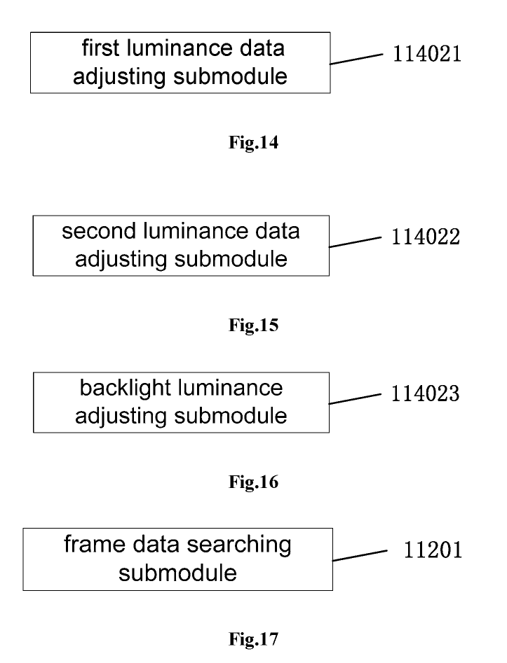

In another embodiment of the present disclosure, as shown in FIG. 14, the energy efficiency control executing submodule in FIG. 13 includes:
a first luminance data adjusting submodule 114021 is configured to adjust the luminance data in the frame data to the luminance threshold value.

As for the television, the energy consumption mainly depends on the display screen, i.e., reduction of the whole energy consumption of the television means to reduction of the energy consumption of the display screen. Wherein, the energy consumption of the display screen is mainly used for displaying an image, and thus the energy consumption of the display screen can be reduced by adjusting the image displayed by the display screen.

In addition, since the luminance of the image has a great influence on the energy consumption, the energy consumption of the display screen can be reduced by adjusting the luminance of the image in the embodiment of the present disclosure, specifically, adjusting luminance data in the frame data to the luminance threshold value. Wherein, the frame data represents data of the image to be displayed by the display screen, and luminance data in the frame data represents the luminance of the image.

In the embodiment of the present disclosure, the luminance threshold value is used as a standard to adjust the luminance of the image, so as to improve the accuracy of the energy efficiency control for the television.

In another embodiment of the present disclosure, as shown in FIG. 15, the energy efficiency control executing submodule in FIG. 13 includes:
a second luminance data adjusting submodule 114022 is configured to adjust the luminance data in the frame data to 70%-80% of current luminance data.

The embodiment of the present disclosure is basically similar with the above embodiments, which also reduces the energy consumption of the television by reducing the luminance of the image. The difference is that if it is determined that the luminance data is larger than the preset luminance threshold value in the embodiment of the present disclosure, the luminance of the image displayed by the display screen is directly adjusted to 70%-80% of the current luminance, specifically, adjusting luminance data in the frame data to 70%-80% of the current luminance data. Wherein, the adjustment ratio of the luminance data can be arbitrary data among 70%-80%, which is not limited in the present disclosure.

That is to say, in the embodiment of the present disclosure, the data processing amount of the television is reduced by equal-proportionally reducing directly according to the current luminance of the image, rather than taking the luminance threshold value as a standard to adjust the luminance of the image any more, which is easily implemented.

In another embodiment of the present disclosure, as shown in FIG. 16, the energy efficiency control executing submodule in FIG. 13 includes:
a backlight luminance adjusting submodule 114023 is configured to adjust the backlight luminance of the television to 70%-80% of current backlight luminance

The display screen provides the backlight luminance by the backlight, and the backlight is always in a lightening state after the television is opened. Therefore, in the embodiment of the present disclosure, the energy consumption of the television can be reduced by adjusting the luminance of the backlight, thereby realizing the energy efficiency control for the television.

Since the backlight is merely a light-emitting device in the television, the energy efficiency control can be performed for the television by adjusting the luminance of the backlight, which is easily implemented.

In another embodiment of the present disclosure, as shown in FIG. 17, the frame data searching module in FIG. 11 includes:
a frame data searching submodule 11201 is configured to search for frame data of two or more frames corresponding to the cache address, wherein the frame data of two or more frames is continuous frame data.

Since the frame data is a continuous data stream, frame data of two or more frames is searched for according to the cache address, in order to determine types of the frame data in the subsequent step. Wherein, the number of the frame data may be an arbitrary numerical value of more than two frames, e.g. three frames, four frames, five frames, etc., which is not limited in the present disclosure.

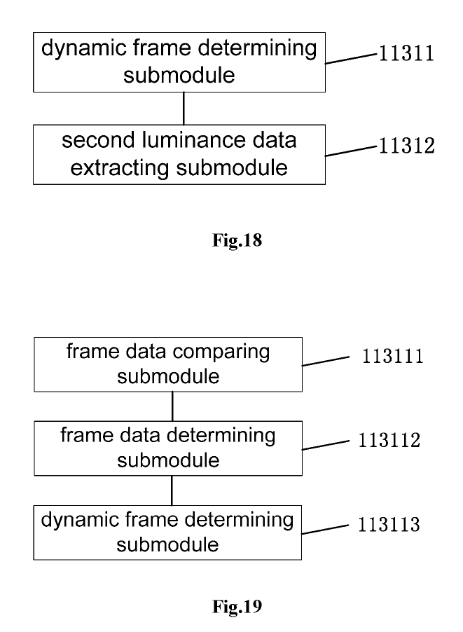

In another embodiment of the present disclosure, as shown in FIG. 18, the frame data searching submodule in FIG. 17 includes:
a dynamic frame determining submodule 11311 is configured to determine whether the frame data is a dynamic frame.

In a normal case, the screens played in the television includes a dynamic screen (such as television play or movie) and a static screen (such as static pictures), wherein the data frame corresponding to the dynamic screen is a dynamic frame, and the data frame corresponding to the static screen is a static frame.

Since the television has a higher energy consumption while playing the dynamic screen, and has a lower energy consumption while playing the static screen, it merely needs to perform energy efficiency control for the television when the television plays the dynamic screen.

A second luminance data extracting submodule 11312 is configured to extract luminance data in the frame data as the energy consumption parameter information if the frame data is the dynamic frame.

In the embodiment of the present disclosure, luminance data in the frame data is extracted as the energy consumption parameter information if the frame data is the dynamic frame. That is to say, the luminance data in the frame data can be extracted only if the frame data is the dynamic frame, so as to perform energy efficiency control for the television in the subsequent step. If the frame data is the static frame, it does not need to perform energy efficiency control for the television, and thus it is unnecessary to extract the luminance data in the frame data.

In the embodiment of the present disclosure, the type of the frame data is used as an energy efficiency control condition of the television, thereby using different energy efficiency control strategies for different frame data and thus improving the energy efficiency control accuracy of the television.

In another embodiment of the present disclosure, as shown in FIG. 19, the dynamic frame determining submodule in FIG. 18 includes:
a frame data comparing submodule 113111 is configured to compare frame data of two or more frames two by two.

In the embodiment of the present disclosure, the frame data of each frame represents one image, and comparing the frame data two by two means to comparison of the images represented by respective frames two by two.

A frame data determining submodule 113112 is configured to determine whether there is difference among the frame data of two frames.

If the frame data of two frames are identical, it is represented that two images are identical, i.e., the images played in the television are static images. If the frame data of two frames are different, it is represented that two images are different, i.e., the images played in the television are dynamic images. Thus, the type of the frame data can be determined according to a result of comparison among different frames.

In the embodiment of the present disclosure, it is determined that the frame data is the dynamic frame if there is difference among frame data of two arbitrary frames.

A dynamic frame determining submodule 113113 is configured to determine that the frame data is the dynamic frame if there is difference among frame data of two frames.

If there is difference among the frame data of two frames, it is represented that two images played in the television are different, so that the images played in the television are dynamic images, and the frame data corresponding to the dynamic images is the dynamic frame.

In the embodiment of the present disclosure, the type of the frame data is determined by comparing the frame data of two arbitrary frames, and the determination result is accurate and reliable.

The embodiment of the present disclosure further provides a television, which includes part or all of modules in respective modes of the device for controlling energy efficiency of the television provided by the embodiments stated in FIGS. 11-19 of the present disclosure.

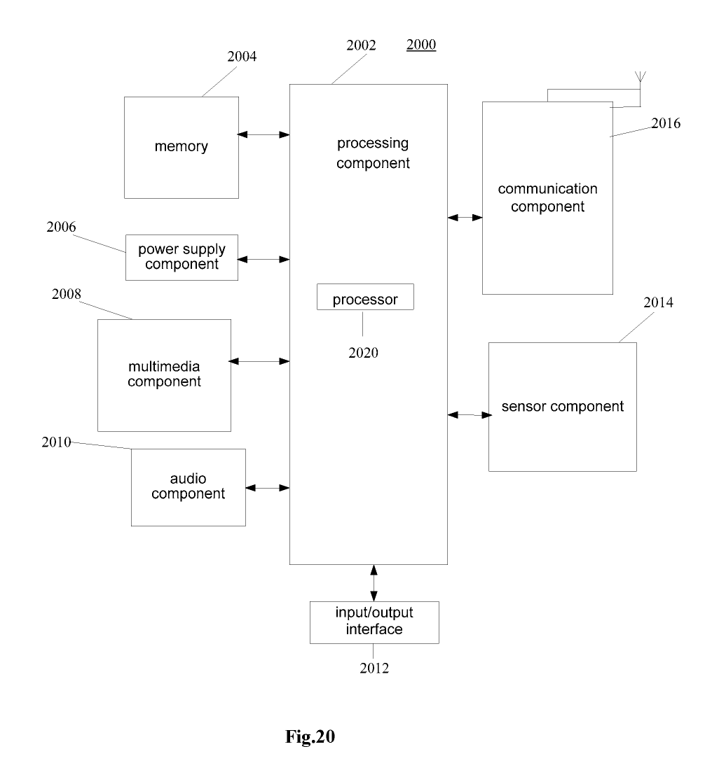

FIG. 20 is a structural flowchart of a television illustrated according to an exemplary embodiment. Referring to FIG. 20, the television 2000 may include one or more components as follows: a processing component 2002, a memory 2004, a power supply component 2006, a multimedia component 2008, an audio component 2010, an input/output (I/O) interface 2012, a sensor component 2014 and a communication component 2016.

The processing component 2002 commonly controls the entire operation of the television 2000, such as operations associated with display, telephone call, data communication, camera operation and recording operation. The processing component 2002 may include one or more processors 2020 to execute instructions, so as to complete all or part of steps in the above method. Furthermore, the processing component 2002 may include one or more modules, so as to facilitate interaction between the processing component 2002 and other components. For instance, the processing component 2002 may include a multimedia module, so as to facilitate interaction between the multimedia component 2008 and the processing component 2002.

The memory 2004 is configured to store various types of data to support the operation of the television 2000. The examples of these data include instructions of respective applications or methods operated on the television 2000, contact person data, telephone book data, message, picture, video, etc. The memory 2004 may be realized by any type of volatile or non-volatile storage device or the combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disc or an optical disk.

The power supply component 2006 supplies power to various kinds of components of the television 2000. The power supply component 2006 may include a power supply management system, one or more power supplies, and other components associated with generation, management and distribution of power to the television 2000.

The multimedia component 2008 includes a screen for providing an output interface between the television 2000 and a user. In some embodiments, the screen may include a liquid crystal display (LCD) and a touch panel (TP). If the screen includes the touch panel, the screen can be implemented as a touch screen to receive an input signal from the user. The touch panel includes one or more touch sensors to sense the gestures of touching and sliding on the touch panel. The touch sensor does not only sense the boundary of the touching or sliding operation, but also detect a persistent period and pressure related to the touching or sliding operation. In some embodiments, the multimedia component 2008 includes a front-facing camera and/or a rear-facing camera. When the television 2000 is in an operating mode (e.g. a shooting mode or a video mode), the front-facing camera and/or the rear-facing camera can receive multimedia data from the external. Each of the front-facing camera and the rear-facing camera may be a fixed optical lens system or has capabilities of focusing and optically zooming.

The audio component 2010 is configured to output and/or input audio signals. For instance, the audio component 2010 includes a microphone (MIC), and when the television 2000 is in an operating mode (e.g. a call mode, a recording mode and a speech recognition mode), the microphone is configured to receive audio signals from the external. The received audio signal may be further stored in the memory 2004 or transmitted via the communication component 2016. In some embodiments, the audio component 2010 further includes a speaker for outputting the audio signals.

The I/O interface 2012 provides an interface between the processing component 2002 and a peripheral interface module, wherein the peripheral interface module may be a keyboard, a click wheel, a button, etc. These buttons may include but are not limited to a homepage button, a volume button, a start button and a locking button.

The sensor component 2014 includes one or more sensors, which are used for providing state evaluation in respective aspects for the television 2000. For instance, the sensor component 2014 may detect an ON/OFF state of the television 2000, and relative location of the component, e.g. the component is a display and a keypad of the television 2000. The sensor component 2014 may also detect change in position of the television 2000 or one component of the television 2000, presence or absence of contact between the user and the television 2000, orientation or acceleration/deceleration of the television 2000 and change in temperature of the television 2000. The sensor component 2014 may include a proximity sensor, which is configured to detect presence of a proximity object when there is no any physical contact. The sensor component 2014 may also include an optical sensor (such as a CMOS or CCD image sensor), which is applied to the imaging application. In some embodiments, the sensor component 2014 may also include an acceleration sensor, a gyroscope sensor, a magnetic sensor, a pressure sensor or a temperature sensor.

The communication component 2016 is configured to facilitate a wired or wireless communication between the television 2000 and other devices. The television 2000 may be accessed to a communication-standard-based wireless network, such as WiFi, 2G, 3G or the combination of them. In an exemplary embodiment, the communication component 2016 receives broadcast signals or information related to broadcast from an external broadcast management system via a broadcast channel. In an exemplary embodiment, the communication component 2016 further includes a near field communication (NFC) module to accelerate a short-ranged communication. For instance, the short-rang communication can be realized by the NFC module based on a radio frequency identification devices (RFID) technology, an infrared data association (IrDA) technology, an ultra wide bandwidth (UWB) technology, a Bluetooth (BT) technology and other technologies.

In the exemplary embodiment, the television 2000 can be implemented by one or more application specific integrated circuits (ASIC), digital signal processor (DSP), digital signal processor device (DSPD), programmable logic device (PLD), field programmable gate array (FPGA), controller, microcontroller, microprocessor or other electronic elements, which is used for executing the above methods.

In the exemplary embodiment, a non-transitory computer readable storage medium including instructions is further provided, such as the memory 2004 including instructions. The instructions can be executed by the processor 2020 of the television 2000 to complete the above methods. For instance, the non-transitory computer readable storage medium may be a ROM, a random access memory (RAM), a CD-ROM, a tape, a floppy disk, an optical data storage device or the like.

The non-transitory computer readable storage medium enables the television to be capable of executing a method for controlling energy efficiency when the instructions in the storage medium are executed by the processor of the television, wherein the method includes:
acquiring a cache address of frame data input by an external device from an application layer;
searching for frame data corresponding to the cache address;
extracting energy consumption parameter information from the frame data; and
performing energy efficiency control for the television according to the energy consumption parameter information.

When the instructions in the storage medium are executed, except for realizing the above methods, part or all of steps in the respective modes of the method for controlling energy efficiency provided by the embodiments shown in FIGS. 2-10 can also be realized.

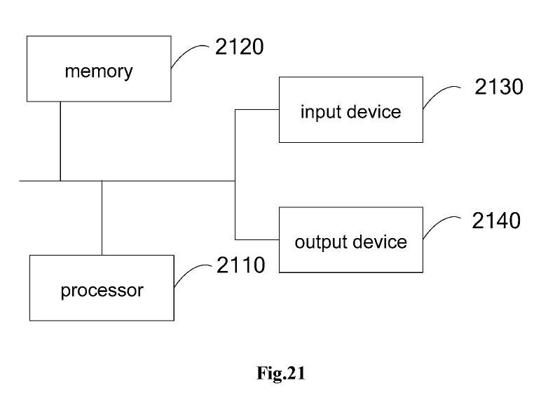

FIG. 21 is a structural schematic diagram of an electronic device that performs method for controlling television energy efficiency provided by an embodiment of the present disclosure. As shown in FIG. 21, the device includes:

one or more processors 2110 and a memory 2120. FIG. 21 illustrates one processor 2110 as an example.

The device that executes the method for controlling television energy efficiency may further include an input device 2130 and an output device 2140.

The processor 2110, the memory 2120, the input device 2130 and the output device 2140 may be connected with each other through bus or other means. FIG. 21 illustrates bus connection as an example.

As a non-transitory computer readable storage medium, the memory 2120 may be configured to store non-transitory software program, non-transitory computer executable program and modules, such as program instructions/modules corresponding to the method for controlling television energy efficiency according to the embodiments of the disclosure(For example, cache address acquiring module 11100, frame data searching module 11200, energy consumption parameter information extracting module 11300 and energy efficiency control module 11400 shown in FIG. 11). By executing the non-transitory software program, instructions and modules stored in the memory 2120, the processor 2110 may perform various functional applications of the server and data processing, that is, the method for controlling television energy efficiency according to the above mentioned embodiments.

The memory 2120 may include a program storage area and a data storage area, wherein, the program storage area may be stored with the operating system and applications which are needed by at least one functions, and the data storage area may be stored with data which is created according to use of the device for controlling television energy efficiency. Further, the memory 2120 may include a high-speed random access memory, and may further include non-transitory memory, such as at least one of disk memory device, flash memory device or other types of non-transitory solid state memory device. In some embodiments, optionally, the memory 2120 may include memory provided remotely from the processor 2110, and such remote memory may be connected with the device for controlling television energy efficiency through network, the examples of the networks may include but not limited to internet, intranet, LAN (Local Area Network), mobile communication network or combinations thereof.

The input device 2130 may receive inputted number or character information, and generate key signal input related to the user settings and functional control of the device for controlling television energy efficiency. The output device 2140 may include a display device such as a display screen.

The above one or more modules may be stored in the memory 2120, when these modules are executed by the one or more processors 1110, the method for controlling television energy efficiency according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and include several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. (canceled)

2. The method for controlling television energy efficiency according to claim 8, wherein the extracting energy consumption parameter information from the frame data comprises:
extracting luminance data in the frame data as the energy consumption parameter information.

3. A method for controlling television energy efficiency which is applied to a television, the method comprising:
acquiring a cache address of frame data input by an external device from an application layer;
searching for frame data corresponding to the cache address;
extracting energy consumption parameter information from the frame data; and
performing energy efficiency control for the television according to the energy consumption parameter information;
wherein the extracting energy consumption parameter information from the frame data comprises:
extracting luminance data in the frame data as the energy consumption parameter information; and
wherein the performing energy efficiency control for the television according to the energy consumption parameter information comprises:
determining whether the luminance data is larger than a preset luminance threshold value; and
performing energy efficiency control for the television if the luminance data is larger than the preset luminance threshold value.

4. The method for controlling television energy efficiency according to claim 3, wherein the performing energy efficiency control for the television comprises:
adjusting the luminance data in the frame data to the luminance threshold value.

5. The method for controlling television energy efficiency according to claim 3, wherein the performing energy efficiency control for the television comprises:
adjusting the luminance data in the frame data to 70%-80% of current luminance data.

6. The method for controlling television energy efficiency according to claim 3, wherein the performing energy efficiency control for the television comprises:
adjusting a backlight luminance of the television to 70%-80% of current backlight luminance.

7. The method for controlling television energy efficiency according to claim 3, wherein the searching for frame data corresponding to the cache address comprises:
searching for frame data of two or more frames corresponding to the cache address, wherein the frame data of two or more frames is continuous frame data.

8. A method for controlling television energy efficiency which is applied to a television, the method comprising:
acquiring a cache address of frame data input by an external device from an application layer;
searching for frame data corresponding to the cache address;
extracting energy consumption parameter information from the frame data; and
performing energy efficiency control for the television according to the energy consumption parameter information;
wherein the searching for frame data corresponding to the cache address comprises:
searching for frame data of two or more frames corresponding to the cache address, wherein the frame data of two or more frames is continuous frame data; and
wherein the extracting energy consumption parameter information from the frame data comprises:
determining whether the frame data is a dynamic frame; and
extracting, if the frame data is the dynamic frame, luminance data in the frame data as the energy consumption parameter information.

9. The method for controlling television energy efficiency according to claim 8, wherein the determining whether the frame data is the dynamic frame comprises:
comparing the frame data of two or more frames two by two;
determining whether there is difference among the frame data of two frames; and
determining, if there is difference among the frame data of two frames, that the frame data is the dynamic frame.

10.-12. (canceled)

13. The electronic device, comprising:
one or more processors; and
a memory communicably connected with the at least one processor for storing instructions executable by the at least one processor, wherein execution of the instructions by the at least one processor causes the at least one processor to:
acquire a cache address of frame data input by an external device from an application layer;
search for frame data corresponding to the cache address;
extract energy consumption parameter information from the frame data; and
perform energy efficiency control for the television according to the energy consumption parameter information;
wherein the step to extract energy consumption parameter information from the frame data causes to:
extract luminance date in the frame data as the energy consumption parameter information; and
wherein the step to perform energy efficiency control for the television according to the energy consumption parameter information causes to:
determine whether the luminance date is larger than a preset luminance threshold value; and
perform energy efficiency control for the television if the luminance data is large than the preset luminance threshold value.

14. The electronic device according to claim 13, wherein the step to perform energy efficiency control for the television causes the at least one processor to:
adjust the luminance data in the frame data to the luminance threshold value.

15. The electronic device according to claim 14, wherein the step to perform energy efficiency control for the television causes the at least one processor to:
adjust the luminance data in the frame data to 70%-80% of current luminance data.

16. The electronic device according to claim 14, wherein the step to perform energy efficiency control for the television causes the at least one processor to:
adjust a backlight luminance of the television to 70%-80% of current backlight luminance.

17. The electronic device according to claim 13, wherein the step to search for frame data corresponding to the cache address causes the at least one processor to:
search for frame data of two or more frames corresponding to the cache address, wherein the frame data of two or more frames is continuous frame data.

18. The electronic device according to claim 17, wherein the step to extract energy consumption parameter information from the frame data causes the at least one processor to:
determine whether the frame data is a dynamic frame; and
extract, if the frame data is the dynamic frame, luminance data in the frame data as the energy consumption parameter information.

19. The electronic device according to claim 18, wherein the step to determine whether the frame data is the dynamic frame causes the at least one processor to:
compare the frame data of two or more frames two by two;
determine whether there is difference among the frame data of two frames; and
determine, if there is difference among the frame data of two frames, that the frame data is the dynamic frame.

20. The method for controlling television energy efficiency according to claim 4, wherein the performing energy efficiency control for the television comprises:
adjusting a backlight luminance of the television to 70%-80% of current backlight luminance.

21. The method for controlling television energy efficiency according to claim 4, wherein the searching for frame data corresponding to the cache address comprises:
searching for frame data of two or more frames corresponding to the cache address, wherein the frame data of two or more frames is continuous frame data.

22. The method for controlling television energy efficiency according to claim 7, wherein the performing energy efficiency control for the television comprises:
adjusting the luminance data in the frame data to 70%-80% of current luminance data.

23. The method for controlling television energy efficiency according to claim 7, wherein the performing energy efficiency control for the television comprises:
adjusting a backlight luminance of the television to 70%-80% of current backlight luminance.

24. The method for controlling television energy efficiency according to claim 8, wherein the performing energy efficiency control for the television comprises:
adjusting the luminance data in the frame data to the luminance threshold value.
